(19) United States
(12) Patent Application Publication
(10) Pub. No.: US 2022/0139026 A1
(43) Pub. Date: May 5, 2022

(54) Latency-Resilient Cloud Rendering

(71) Applicant: Facebook Technologies, LLC, Menlo Park, CA (US)

(72) Inventors: Reza Nourai, Danville, CA (US); Volga Aksoy, Redwood City, CA (US); Zeyar Htet, San Mateo, CA (US)

(21) Appl. No.: 17/090,627

(22) Filed: Nov. 5, 2020

(51) Int. Cl. G06T 15/10; G06T 3/40; G06T 15/60; G06T 7/536; G06T 7/80

(52) U.S. Cl. CPC G06T 15/10; G06T 3/4053; G06T 7/80; G06T 7/536; G06T 15/60

(57) ABSTRACT

In one embodiment, a method includes the steps of generating, for a virtual object defined by a geometric representation, multiple viewpoints surrounding the virtual object, generating, for each of the multiple viewpoints, a simplified geometric representation of the virtual object based on the viewpoint, wherein the simplified geometric representation has a lower resolution than the geometric representation of the virtual object, receiving, from a client device, a desired viewpoint from which to view the virtual object, selecting one or more viewpoints from the multiple viewpoints based on the desired viewpoint, and sending, to the client device, rendering data including the simplified geometric representation and an associated view-dependent texture that are associated with each of the selected one or more viewpoints, the rendering data being configured for rendering an image of the virtual object from the desired viewpoint.

### TECHNICAL FIELD

This disclosure generally relates to rendering Augmented-Reality (AR) or Virtual-Reality (VR) content on user devices. This disclosure generally relates to storing and rendering AR/VR content on a cloud architecture.

### BACKGROUND

Virtual reality is a computer-generated simulation of an environment (e.g., a 3D environment) that users can interact with in a seemingly real or physical way. A virtual reality system, which may be a single device or a group of devices, may generate this simulation for display to a user, for example, on a virtual reality headset or some other display device. The simulation may include images, sounds, haptic feedback, and/or other sensations to imitate a real or imaginary environment. As virtual reality becomes more and more prominent, its range of useful applications is rapidly broadening. The most common applications of virtual reality involve games or other interactive content, but other applications such as the viewing of visual media items (e.g., photos, videos) for entertainment or training purposes are close behind. The feasibility of using virtual reality to simulate real-life conversations and other user interactions is also being explored.

Augmented reality provides a view of the real or physical world with added computer-generated sensory inputs (e.g., visual, audible). In other words, computer-generated virtual effects may augment or supplement the real-world view. For example, a camera on a virtual reality headset may capture a real-world scene (as an image or video) and display a composite of the captured scene with computer-generated virtual objects. The virtual objects may be, for example, two-dimensional and/or three-dimensional objects, and may be stationary or animated.

### BRIEF DESCRIPTION OF THE DRAWINGS

FIG. 1 illustrates an example of a view hierarchy surrounding an object.

FIG. 2. illustrates an example of a view hierarchy and a user's viewpoint.

FIGS. 3A-3B illustrate the process of rendering an image of a virtual object based on rendering data.

FIG. 4 illustrates a diagram of a server that generates the rendering data and a device that performs the reconstruction process.

FIG. 5 illustrates an example method for generating a view hierarchy of a virtual object.

FIG. 6 illustrates an example method for determining viewpoints that are relevant to a user and providing rendering data associated with the relevant viewpoints.

FIG. 7 illustrates an example method for rendering an image of a virtual object based on rendering data.

FIG. 8 illustrates an example network environment associated with a social-networking system.

FIG. 9 illustrates an example computer system.

### SUMMARY OF PARTICULAR EMBODIMENTS

The invention of this disclosure is directed to addressing problems associated with providing high-quality AR/VR content to light-weight, low-cost devices, such as mobile phones. The invention aims to provide a latency-resilient AR/VR experience by utilizing cloud rendering for the bulk of intensive computing while leveraging local reconstruction on a user device so the latency for the final rendering is largely decoupled from network conditions. Traditional cloud-rendering approaches use a server to perform all rendering tasks and send only the final video stream to the client device. But due to latency caused by the rendering process and network transmission, by the time the video is displayed to the user, the viewpoint used by the server to render the video would likely be different from the viewpoint of the user. The difference in the viewpoints would manifest as lag, and the lag would become especially pronounced when the geometry of the virtual object is complex and the network condition is poor. To address these issues, the invention uses a server to perform the heavy-duty rendering tasks and encodes artifacts of 3D objects (e.g., simplified geometry and RGB data). Those artifacts are then sent to and used by the user device to reconstruct an image of the object using the most up-to-date viewpoint of the user.

The reconstruction scheme takes advantage of the fact that, at any given time, a user in an AR/VR environment will only be able to see portion of an object from the user's “viewpoint,” or perspective (e.g., the portion of the object that can be seen by the user at the user's position). This means that an object that is rendered for a user may not need to be rendered in its entirety. Instead, only the portions of the object that are relevant to the user's viewpoint may need to be rendered (e.g., portions of the object that can be seen from the user's view). Embodiments of this invention provide a method for encoding a virtual object based on various viewpoints surrounding the object, each viewpoint being associated with a simplified geometric representation and associated view-dependent texture (e.g., rendering data). Once an object is encoded (e.g., by a server) based on various viewpoints of the object, viewpoints that are relevant to a user could be determined and rendering data associated with the relevant viewpoints may be provided to the user device. The user device may then reconstruct the object from the user's viewpoint using the rendering data received from the server.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### DESCRIPTION OF EXAMPLE EMBODIMENTS

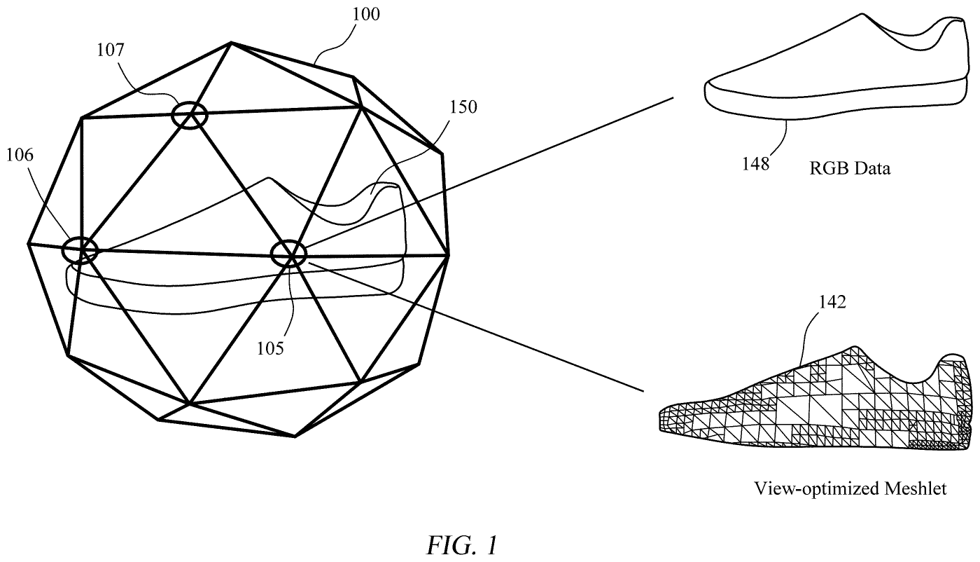

The invention of this disclosure presents a method of encoding objects based on a view-dependent architecture called the “view hierarchy.” A view hierarchy is a layout of multiple viewpoints surrounding an object, each viewpoint being associated with a representation of the object that captures the object's geometry and texture from that viewpoint. FIG. 1 illustrates an example of a view hierarchy 100 surrounding an object 150. Each vertex of the view hierarchy 100 represents a viewpoint from that point in space, three of which are illustrated as viewpoints 105, 106, and 107. In particular embodiments, the viewpoints of a view hierarchy are distributed based on an equirectangular layout, similar to a globe of the Earth. The viewpoints of the view hierarchy may be distributed in a way such that the largest number of viewpoints are distributed around the equator, or 0 degree latitude, and decreasing number of viewpoints are distributed along other non-zero degree latitudes further they are away from the equator. In other embodiments, the viewpoints of a view hierarchy may be distributed based on different layouts, such as a geodesic distribution. In particular embodiments, a view hierarchy may be comprised of multiple triangles called “view triangles,” each triangle formed by three viewpoints. For example, FIG. 1 illustrates a view triangle formed by viewpoints 105, 106, and 107. In the embodiment illustrated in FIG. 1, the view hierarchy 100 is comprised of a single layer of viewpoints surrounding the object 150, such that all the viewpoints are placed a fixed distance away from the center of the object 150. In other embodiments, a view hierarchy may be comprised of two or more layers, such that the viewpoints of different layers are placed at different distances away from the center of an object. If, for example, a view hierarchy is comprised of two layers, viewpoints in the first layer may be distributed so the first layer is comprised of multiple view triangles, and additional viewpoints may be distributed in the second layer so they form “view tetrahedrons” with the view triangles from the first layer. Embodiments with multiple layers of viewpoints may be advantageous since an object can be encoded based on viewpoints of different depths.

In particular embodiments, a virtual object may be encoded by generating a representation of the object from each of the viewpoints surrounding the object. Each representation associated a viewpoint may include two types of data: (1) “surface proxy” or “meshlet,” which represents a simplified representation of the object's geometry from the viewpoint; and (2) RGB data, which represents the view-dependent texture of the meshlet. For example, FIG. 1 illustrates meshlet 142 and RGB data 148 corresponding to viewpoint 105 of the view hierarchy 100.

A meshlet is a fragment of the object's geometry that represents the overall volume and shape of the object from a specific viewpoint (or set of viewpoints) based on depth information. A meshlet only represents a portion of the object from a viewpoint, so moving around behind the meshlet will reveal that it is an empty shell. In other words, a meshlet is a simplified geometry of the original object's complex geometry and is derived from depth data. Thus, the density and quality of the meshlet is impacted by depth buffer resolution, not geometric complexity of the object. In particular embodiments, a meshlet may be produced by leveraging a rasterization process. Starting with a sparse grid (e.g., 128×128 pixel) overlaying a depth buffer, the range of depth values associated with each cell of the grid (e.g., minimum and maximum depth values) are evaluated to determine the appropriate size of the cell. If the range of depth values associated with any one cell is too large to be represented by the cell, the cell may be subdivided evenly into quarters in a recursive manner until each of the subdivided cells is appropriately sized for the range of depth values associated with the cell, or until the cell reaches the minimum cell size (e.g., 2×2 pixels). Once the appropriate sizes for the cells are determined, each of the cells are divided into two triangles by inserting a diagonal line through the cell (in some embodiments, the cells may be divided into a polygon shape different than a triangle). If any of the triangle's vertices extend beyond a cutoff threshold, the triangles may be discarded. This means that the number of triangles resulting from any one cell could be none, one, or two. Once the triangles are generated, a depth cliff filter may be applied by further discarding any triangles with slopes (e.g., depth delta) that are beyond a workable range. For all remaining triangles, the vertices of the triangles are mapped to x and y values of a x-y coordinate space and z value based on the depth buffer. This meshlet generating method eliminates all the empty space that are not part of the object and dynamically adjusts the triangle density to adapt to areas where the depth complexity is highest (e.g., edges). FIG. 1 illustrates an example meshlet 142 produced by this method. Meshlets do not need to be recomputed or updated unless the geometry of the object changes, thus, generally, meshlets can be pre-computed and saved in a “ready to consume” fashion. In particular embodiments, the meshlets corresponding to the several viewpoints may be combined to generate a single unified meshlets. For example, the meshlets of the primary views may be combined as a single unified meshlet that represents a simplified geometry of the object from all three viewpoints (e.g., view triangle).

RGB data is a texture rendering of an object from the perspective of a viewpoint (e.g., view-dependent texture). The meshlet and RBG data are designed such that, when combined based on the methods described herein, the resulting image would be virtually indistinguishable from the original object rendering. In particular embodiments, instead of rendering separate RGB data for each individual viewpoints, a higher-quality RGB data may be rendered for several nearby viewpoints. This is possible because RGB data of several nearby viewpoints may not differ substantially from each other (e.g., texture of an object from any one viewpoint often looks similar from those of nearby viewpoints). In particular embodiments, a server may analyze the user's position and trajectory in a virtual environment then provide meshlets and RGB data (corresponding to viewpoints of a view hierarchy) that the user may need for reconstructing an object.

The reconstruction process of an object is performed locally by a user device based on a view hierarchy of the object. In particular embodiments, the reconstruction process involves determining a user's viewpoint with respect to the view hierarchy of the object by projecting a ray from the user's viewpoint to the center of the object and determining the point at which the ray intersects the view hierarchy (referred to as the “hit point”). For example, FIG. 2 illustrates a ray 220 projected between a user's viewpoint 210 (e.g., a virtual camera location) and the center point of the object 215. The point at which the ray 220 intersects the view hierarchy 100 is referred to as the hit point 250. Next, the view triangle enclosing the hit point 250 is identified and the three viewpoints forming the view triangle are selected as “primary views” (e.g., viewpoints 105, 106, and 107). Then, the barycentric coordinate of the user's viewpoint 210 with respect to the view triangle (formed by the primary views) may be determined. As explained more below, the reconstruction process performed by a device may involve rendering, for each of the primary views, an image of the object from the user's viewpoint based on the meshlets and RGB data corresponding to the primary view, then blending the images based on the barycentric coordinate of the user's viewpoint with respect to the primary views.

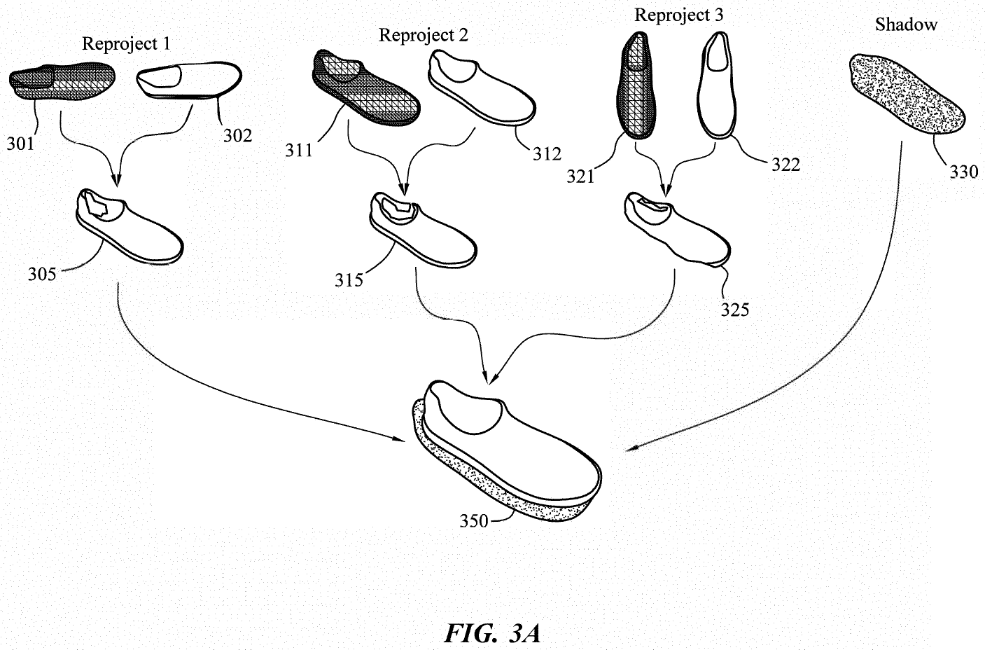

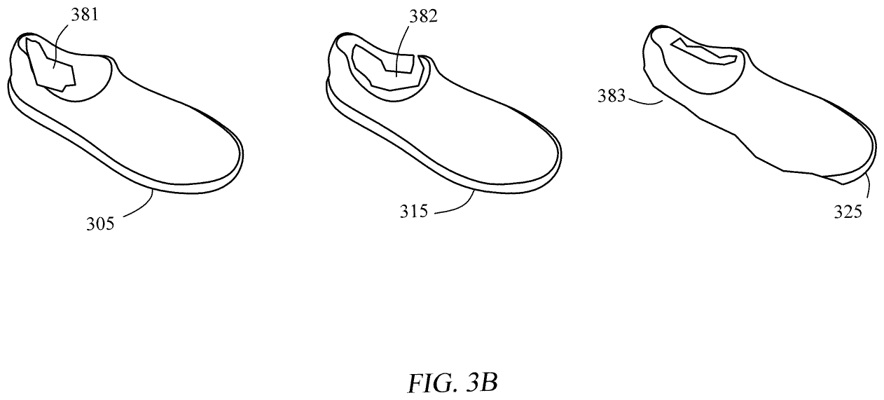

FIGS. 3A-3B illustrate the process of rendering, for each of the primary views, an image of the object from a user's viewpoint based on the meshlets and RGB data corresponding to the primary view (e.g., the object is reprojected from the user's viewpoint), then reconstructing the object by combining the reprojected images. For example, FIG. 3A illustrates a reprojection pass for each of the primary views (“Reproject 1,” “Reproject 2,” and “Reproject 3”), in which meshlets and RGB data corresponding to the primary views are rendered into reprojected images of the object from the primary views. Meshlet 301 and RGB data 302 are illustrated as being rendered into reprojected image 305, meshlet 311 and RGB data 312 are illustrated as being rendered into reprojected image 315, and meshlet 321 and RGB data 322 are illustrated as being rendered into projected image 325. In particular embodiments, each of the three reprojection passes may be processed in a separate framebuffer. Each reprojection pass by itself may not be able to fully reconstruct the object because the viewpoints associated with the primary views may differ from a user's viewpoint (e.g., some portions of the object, as viewed from the user's viewpoint, may not be visible from the primary views). Thus, FIG. 3B illustrates reprojected images 305 and 315 missing the object's inside portions 381 and 382, respectively, and reprojected image 325 missing the object's bottom portion 383. After the three reprojection images are generated, a combination pass may be performed using a custom blending operation, in which the three framebuffers comprising the reprojected images are combined based on barycentric weights (e.g., determined based the barycentric coordinate of the user's viewpoint with respect to the primary views). For example, FIG. 3A illustrates the reconstructed image 350 that has been generated by blending the three reprojected images together. In particular embodiments, the custom blending operation may remove portions of the object from the reconstructed image, thereby creating “holes” in the object, if some of the approximations of the object's geometry are associated with low-confidence levels. In such cases, a stencil-based hole filling pass may be performed on the reconstructed object to fill in any holes produced during the custom blending operation. The use of a stencil ensures that only fragments inside the holes are filled. In particular embodiments, in addition to meshlets and RGB data, a server may provide a shadow texture to a user device, allowing the device to render the shadow texture into the reconstructed image of the object. A server may render the shadow texture as a non-view-dependent global shadow texture so only a single shadow texture is rendered for the object. During the reconstruction process, the global shadow texture may have to be transformed or reshaped based on the user's viewpoint to match the object in the reconstructed image. The global shadow texture may be rendered into the reconstructed image during the custom blending operation, or in a separate operation. For example, FIG. 3A illustrates a global shadow texture 330 rendered into the reconstructed image 350.

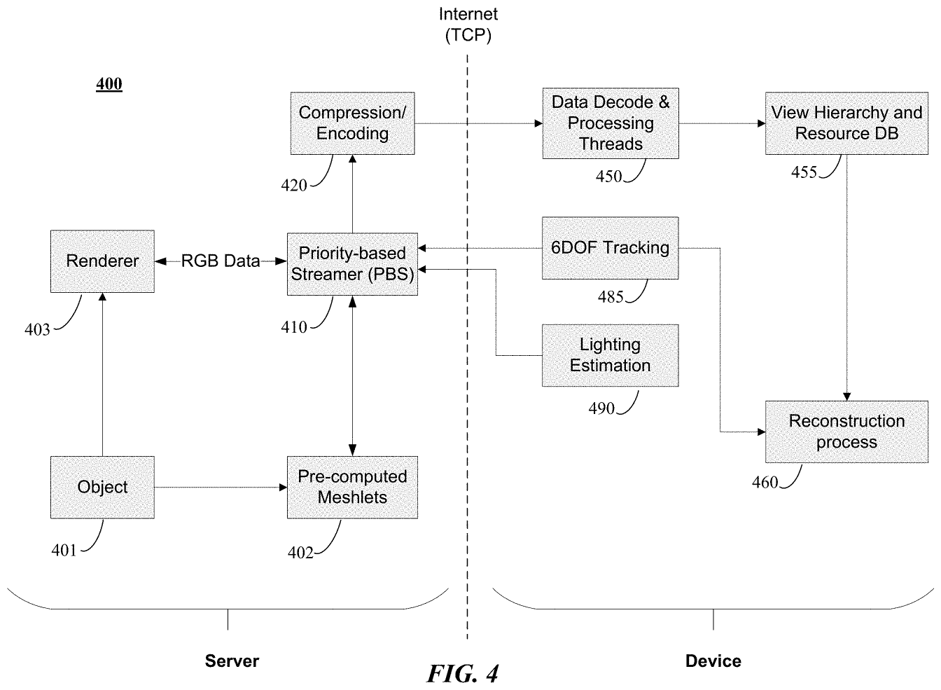

FIG. 4 illustrates a flow diagram 400 between a server that generates the rendering data (e.g., meshlets and RGB data) and a device that performs the reconstruction process. In particular embodiments, as illustrated in FIG. 4, the server may pre-compute an object's 401 meshlets and store the pre-computed meshlets 402 for later use since, generally, the geometry of objects does not change. In particular embodiments, the server may use a renderer 403 to render the RGB data and shadow texture of an object. In contrast to meshlets, RGB data and shadow texture are rendered not only based on the viewpoints but also based on the lighting conditions in the virtual environment. This means that RGB data and shadow texture may need to be rendered and updated much more frequently than meshlets since lighting conditions generally change a lot more frequently than an object's geometry. Thus, in particular embodiments, the renderer 403 may render the RGB data the shadow texture at run-time, as needed, instead of pre-rendering them. In other embodiments, the renderer 403 may pre-render the RGB data and shadow texture in a similar fashion to meshlets, for example, when the lighting conditions do not change frequently.

In particular embodiments, a priority-based streamer (PBS) 410 may determine the viewpoints that are most relevant to a user based on the user's position and trajectory in the virtual environment. For example, the PBS 410 may determine the user's current position and trajectory based on six degrees of freedom (6DOF) tracking information 485 received from the user device. Based on the user's position and trajectory, the PBS 410 may identify viewpoints that the user will likely need for reconstructing an object, which may include viewpoints beyond the three closest viewpoints, e.g., primary views. In particular embodiment, the PBS 410 may prioritize the viewpoints so the user can be provided with more relevant rendering data (e.g., meshlets and RGB data) before less relevant rendering data. For example, the PBS 410 may prioritize the viewpoints based on viewpoints that the user necessarily needs, viewpoints that the user will likely need, and viewpoints that the user may need. Upon identifying the viewpoints relevant to the user, the PBS 410 may request the renderer 403 to render the RGB data for the identified viewpoints. Once the RGB data is rendered for the identified viewpoints, the PBS 410 may provide the RGB data and corresponding pre-computed meshlets to the compression/encoding processor 420 for transmission. In particular embodiments, RGB data may be compressed according to a video compression standard based on block-oriented, motion-compensated integer-DCT coding, such as Advanced Video Encoding (“AVC”) or H.264. Meshlets may be compressed based on a custom meshlet compression algorithm that leverages the uniform spacing of the meshlet vertices. The compressed data may then be provided to a user device.

In particular embodiments, the compressed data received by a user device may be decoded and processed by the data decode and processing threads 450. Once decoded and processed, the data may be provided to the view hierarchy and resource database 455 of the user device. In particular embodiments, a user device may store and maintain its own view hierarchy of the object, thus when meshlets and RGB data for certain viewpoints are received, the device updates the corresponding viewpoints with the received information. In particular embodiments, a user device may utilize a local cache and store meshlets and RGB data received from a server so they can be used for future reconstruction processes.

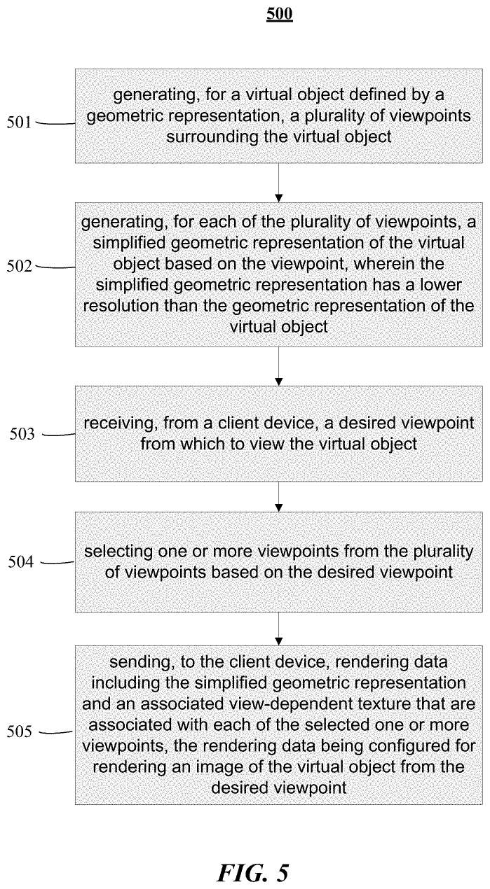

FIG. 5 illustrates an example method 500 for generating a view hierarchy of an object. The method may begin at step 501 by generating, for a virtual object defined by a geometric representation, a plurality of viewpoints surrounding the virtual object. At step 502, the method may continue by generating, for each of the plurality of viewpoints, a simplified geometric representation of the virtual object based on the viewpoint, wherein the simplified geometric representation has a lower resolution than the geometric representation of the virtual object. At step 503, the method may continue by receiving, from a client device, a desired viewpoint from which to view the virtual object. At step 504, the method may continue by selecting one or more viewpoints from the plurality of viewpoints based on the desired viewpoint. At step 505, the method may continue by sending, to the client device, rendering data including the simplified geometric representation and an associated view-dependent texture that are associated with each of the selected one or more viewpoints, the rendering data being configured for rendering an image of the virtual object from the desired viewpoint. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for generating a view hierarchy of an object, this disclosure contemplates any suitable method for generating a view hierarchy of an object including any suitable steps, which may include all, some, or none of the steps of the method of FIG. 5, where appropriate.

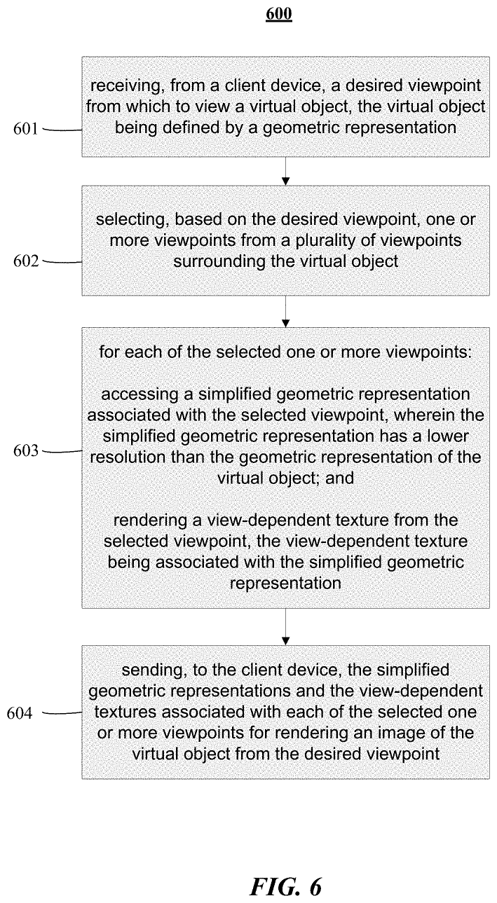

FIG. 6 illustrates an example method 600 for determining viewpoints that are relevant to a user and providing rendering data associated with the relevant viewpoints. The method may begin at step 601 by receiving, from a client device, a desired viewpoint from which to view a virtual object, the virtual object being defined by a geometric representation. At step 602, the method may continue by selecting, based on the desired viewpoint, one or more viewpoints from a plurality of viewpoints surrounding the virtual object. At step 603, the method may continue by, for each of the selected one or more viewpoints: accessing a simplified geometric representation associated with the selected viewpoint, wherein the simplified geometric representation has a lower resolution than the geometric representation of the virtual object; and rendering a view-dependent texture from the selected viewpoint, the view-dependent texture being associated with the simplified geometric representation. At step 604, the method may continue by sending, to the client device, the simplified geometric representations and the view-dependent textures associated with each of the selected one or more viewpoints for rendering an image of the virtual object from the desired viewpoint. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for determining viewpoints that are relevant to a user and providing meshlet data and RGB data associated with the relevant viewpoints to a device associated with the user, this disclosure contemplates any suitable method for determining viewpoints that are relevant to a user and providing meshlet data and RGB data associated with the relevant viewpoints to a device associated with the user including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

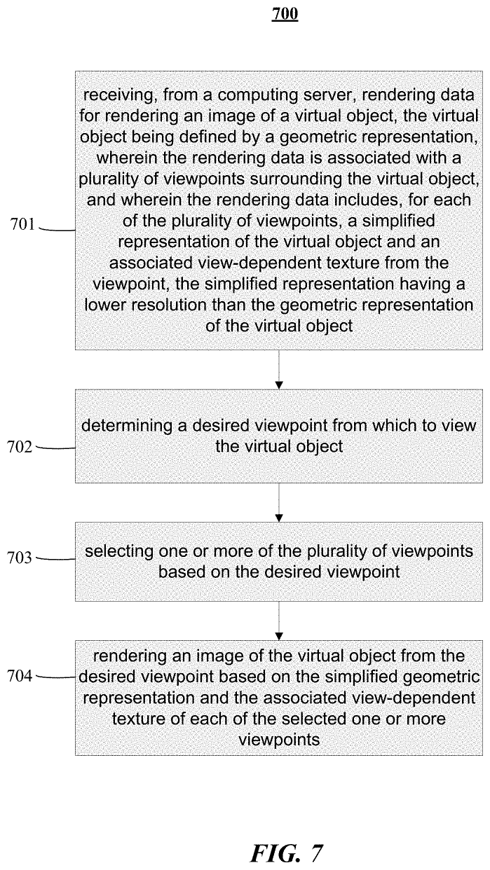

FIG. 7 illustrates an example method 700 for rendering an image of a virtual object based on simplified geometric representations and view-dependent textures of the object. The method may begin at step 701 by receiving, from a computing server, rendering data for rendering an image of a virtual object, the virtual object being defined by a geometric representation, wherein the rendering data is associated with a plurality of viewpoints surrounding the virtual object, and wherein the rendering data includes, for each of the plurality of viewpoints, a simplified representation of the virtual object and an associated view-dependent texture from the viewpoint, the simplified representation having a lower resolution than the geometric representation of the virtual object. At step 702, the method may continue by determining a desired viewpoint from which to view the virtual object. At step 703, the method may continue by selecting one or more of the plurality of viewpoints based on the desired viewpoint. At step 704, the method may continue by rendering an image of the virtual object from the desired viewpoint based on the simplified geometric representation and the associated view-dependent texture of each of the selected one or more viewpoints. Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for reconstructing an object locally on a device, this disclosure contemplates any suitable method for reconstructing an object locally on a device including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

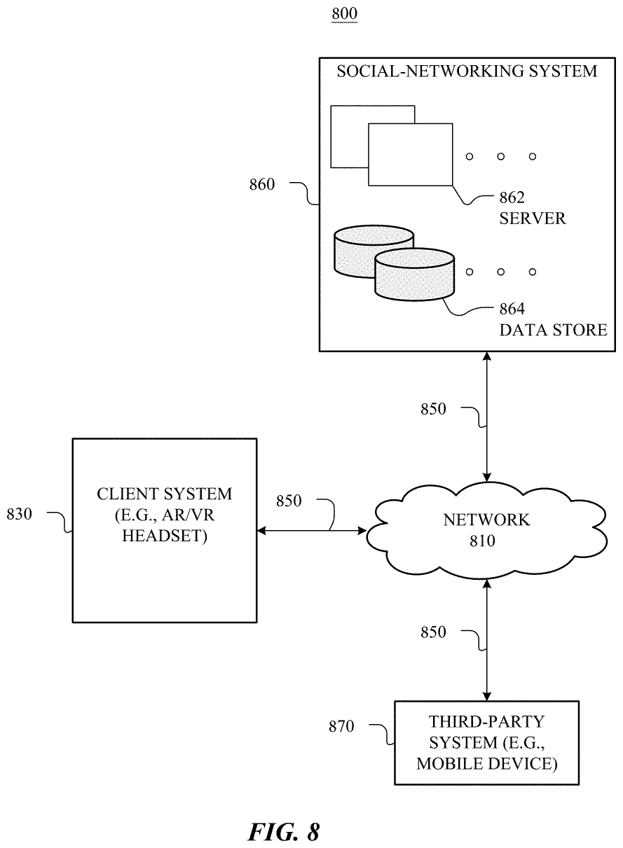

FIG. 8 illustrates an example network environment 800 associated with a social-networking system. Network environment 800 includes a client system 830, a social-networking system 860, and a third-party system 870 connected to each other by a network 810. Although FIG. 8 illustrates a particular arrangement of client system 830, social-networking system 860, third-party system 870, and network 810, this disclosure contemplates any suitable arrangement of client system 830, social-networking system 860, third-party system 870, and network 810. As an example and not by way of limitation, two or more of client system 830, social-networking system 860, and third-party system 870 may be connected to each other directly, bypassing network 810. As another example, two or more of client system 830, social-networking system 860, and third-party system 870 may be physically or logically co-located with each other in whole or in part. For example, an AR/VR headset 830 may be connected to a local computer or mobile computing device 870 via short-range wireless communication (e.g., Bluetooth). Moreover, although FIG. 8 illustrates a particular number of client systems 830, social-networking systems 860, third-party systems 870, and networks 810, this disclosure contemplates any suitable number of client systems 830, social-networking systems 860, third-party systems 870, and networks 810. As an example and not by way of limitation, network environment 800 may include multiple client system 830, social-networking systems 860, third-party systems 870, and networks 810.

This disclosure contemplates any suitable network 810. As an example and not by way of limitation, one or more portions of network 810 may include a short-range wireless network (e.g., Bluetooth, Zigbee, etc.), an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 810 may include one or more networks 810.

Links 850 may connect client system 830, social-networking system 860, and third-party system 870 to communication network 810 or to each other. This disclosure contemplates any suitable links 850. In particular embodiments, one or more links 850 include one or more wireline (such as for example Digital Subscriber Line (DSL) or Data Over Cable Service Interface Specification (DOCSIS)), wireless (such as for example Wi-Fi, Worldwide Interoperability for Microwave Access (WiMAX), Bluetooth), or optical (such as for example Synchronous Optical Network (SONET) or Synchronous Digital Hierarchy (SDH)) links. In particular embodiments, one or more links 850 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 850, or a combination of two or more such links 850. Links 850 need not necessarily be the same throughout network environment 800. One or more first links 850 may differ in one or more respects from one or more second links 850.

In particular embodiments, client system 830 may be an electronic device including hardware, software, or embedded logic components or a combination of two or more such components and capable of carrying out the appropriate functionalities implemented or supported by client system 830. As an example and not by way of limitation, a client system 830 may include a computer system such as a VR/AR headset, desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 830. A client system 830 may enable a network user at client system 830 to access network 810. A client system 830 may enable its user to communicate with other users at other client systems 830.

In particular embodiments, social-networking system 860 may be a network-addressable computing system that can host an online social network. Social-networking system 860 may generate, store, receive, and send social-networking data, such as, for example, user-profile data, concept-profile data, social-graph information, or other suitable data related to the online social network. Social-networking system 860 may be accessed by the other components of network environment 800 either directly or via network 810. As an example and not by way of limitation, client system 830 may access social-networking system 860 using a web browser, or a native application associated with social-networking system 860 (e.g., a mobile social-networking application, a messaging application, another suitable application, or any combination thereof) either directly or via network 810. In particular embodiments, social-networking system 860 may include one or more servers 862. Each server 862 may be a unitary server or a distributed server spanning multiple computers or multiple datacenters. Servers 862 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 862 may include hardware, software, or embedded logic components or a combination of two or more such components for carrying out the appropriate functionalities implemented or supported by server 862. In particular embodiments, social-networking system 860 may include one or more data stores 864. Data stores 864 may be used to store various types of information. In particular embodiments, the information stored in data stores 864 may be organized according to specific data structures. In particular embodiments, each data store 864 may be a relational, columnar, correlation, or other suitable database. Although this disclosure describes or illustrates particular types of databases, this disclosure contemplates any suitable types of databases. Particular embodiments may provide interfaces that enable a client system 830, a social-networking system 860, or a third-party system 870 to manage, retrieve, modify, add, or delete, the information stored in data store 864.

In particular embodiments, social-networking system 860 may store one or more social graphs in one or more data stores 864. In particular embodiments, a social graph may include multiple nodes—which may include multiple user nodes (each corresponding to a particular user) or multiple concept nodes (each corresponding to a particular concept)—and multiple edges connecting the nodes. Social-networking system 860 may provide users of the online social network the ability to communicate and interact with other users. In particular embodiments, users may join the online social network via social-networking system 860 and then add connections (e.g., relationships) to a number of other users of social-networking system 860 to whom they want to be connected. Herein, the term “friend” may refer to any other user of social-networking system 860 with whom a user has formed a connection, association, or relationship via social-networking system 860.

In particular embodiments, social-networking system 860 may provide users with the ability to take actions on various types of items or objects, supported by social-networking system 860. As an example and not by way of limitation, the items and objects may include groups or social networks to which users of social-networking system 860 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 860 or by an external system of third-party system 870, which is separate from social-networking system 860 and coupled to social-networking system 860 via a network 810.

In particular embodiments, social-networking system 860 may be capable of linking a variety of entities. As an example and not by way of limitation, social-networking system 860 may enable users to interact with each other as well as receive content from third-party systems 870 or other entities, or to allow users to interact with these entities through an application programming interfaces (API) or other communication channels.

In particular embodiments, a third-party system 870 may include a local computing device that is communicatively coupled to the client system 830. For example, if the client system 830 is an AR/VR headset, the third-party system 870 may be a local laptop configured to perform the necessary graphics rendering and provide the rendered results to the AR/VR headset 830 for subsequent processing and/or display. In particular embodiments, the third-party system 870 may execute software associated with the client system 830 (e.g., a rendering engine). The third-party system 870 may generate sample datasets with sparse pixel information of video frames and send the sparse data to the client system 830. The client system 830 may then generate frames reconstructed from the sample datasets.

In particular embodiments, the third-party system 870 may also include one or more types of servers, one or more data stores, one or more interfaces, including but not limited to APIs, one or more web services, one or more content sources, one or more networks, or any other suitable components, e.g., that servers may communicate with. A third-party system 870 may be operated by a different entity from an entity operating social-networking system 860. In particular embodiments, however, social-networking system 860 and third-party systems 870 may operate in conjunction with each other to provide social-networking services to users of social-networking system 860 or third-party systems 870. In this sense, social-networking system 860 may provide a platform, or backbone, which other systems, such as third-party systems 870, may use to provide social-networking services and functionality to users across the Internet.

In particular embodiments, a third-party system 870 may include a third-party content object provider (e.g., including sparse sample datasets described herein). A third-party content object provider may include one or more sources of content objects, which may be communicated to a client system 830. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 860 also includes user-generated content objects, which may enhance a user's interactions with social-networking system 860. User-generated content may include anything a user can add, upload, send, or “post” to social-networking system 860. As an example and not by way of limitation, a user communicates posts to social-networking system 860 from a client system 830. Posts may include data such as status updates or other textual data, location information, photos, videos, links, music or other similar data or media. Content may also be added to social-networking system 860 by a third-party through a “communication channel,” such as a newsfeed or stream.

In particular embodiments, social-networking system 860 may include a variety of servers, sub-systems, programs, modules, logs, and data stores. In particular embodiments, social-networking system 860 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 860 may also include suitable components such as network interfaces, security mechanisms, load balancers, failover servers, management-and-network-operations consoles, other suitable components, or any suitable combination thereof. In particular embodiments, social-networking system 860 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 860 to one or more client systems 830 or one or more third-party system 870 via network 810. The web server may include a mail server or other messaging functionality for receiving and routing messages between social-networking system 860 and one or more client systems 830. An API-request server may allow a third-party system 870 to access information from social-networking system 860 by calling one or more APIs. An action logger may be used to receive communications from a web server about a user's actions on or off social-networking system 860. In conjunction with the action log, a third-party-content-object log may be maintained of user exposures to third-party-content objects. A notification controller may provide information regarding content objects to a client system 830. Information may be pushed to a client system 830 as notifications, or information may be pulled from client system 830 responsive to a request received from client system 830. Authorization servers may be used to enforce one or more privacy settings of the users of social-networking system 860. A privacy setting of a user determines how particular information associated with a user can be shared. The authorization server may allow users to opt in to or opt out of having their actions logged by social-networking system 860 or shared with other systems (e.g., third-party system 870), such as, for example, by setting appropriate privacy settings. Third-party-content-object stores may be used to store content objects received from third parties, such as a third-party system 870. Location stores may be used for storing location information received from client systems 830 associated with users. Advertisement-pricing modules may combine social information, the current time, location information, or other suitable information to provide relevant advertisements, in the form of notifications, to a user.

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing server:
generating, for a virtual object defined by a geometric representation, a plurality of viewpoints surrounding the virtual object;
generating, for each of the plurality of viewpoints, a simplified geometric representation of the virtual object based on the viewpoint, wherein the simplified geometric representation has a lower resolution than the geometric representation of the virtual object;
receiving, from a client device, a desired viewpoint from which to view the virtual object;
selecting one or more viewpoints from the plurality of viewpoints based on the desired viewpoint; and
sending, to the client device, rendering data including the simplified geometric representation and an associated view-dependent texture that are associated with each of the selected one or more viewpoints, the rendering data being configured for rendering an image of the virtual object from the desired viewpoint.

2. The method of claim 1, wherein selecting the one or more viewpoints from the plurality of viewpoints based on the desired viewpoint comprises:
prioritizing one or more of the plurality of viewpoints based on a relative location of the desired viewpoint with respect to the virtual object; and
selecting one or more of the plurality of viewpoints based on their prioritization.

3. The method of claim 2, wherein prioritizing the one or more of the plurality of viewpoints is further based on a trajectory of a virtual camera associated with the desired viewpoint.

4. The method of claim 1, wherein, for each of the plurality of viewpoints, the simplified geometric representation is generated prior to receiving the desired viewpoint from the client device.

5. The method of claim 1, wherein, for each of the plurality of viewpoints, the simplified geometric representation is generated further based on a rasterization process.

6. The method of claim 1, further comprising:
generating, for each of the selected one or more viewpoints, the view-dependent texture associated with the simplified geometric representation in response to selecting the one or more viewpoints from the plurality of viewpoints.

7. The method of claim 6, wherein, for each of the selected one or more viewpoints, the view-dependent texture is generated from the selected viewpoint based on lighting conditions within a virtual environment.

8. The method of claim 1, further comprising:
generating a shadow texture of the virtual object based on lighting conditions within a virtual environment, and
wherein the rendering data further includes the shadow texture.

9. The method of claim 8, wherein the shadow texture of the virtual object is generated in response to detecting a change in the lighting conditions within the virtual environment.

10. One or more computer-readable non-transitory storage media embodying software that is operable when executed to:
generate, for a virtual object defined by a geometric representation, a plurality of viewpoints surrounding the virtual object;
generate, for each of the plurality of viewpoints, a simplified geometric representation of the virtual object based on the viewpoint, wherein the simplified geometric representation has a lower resolution than the geometric representation of the virtual object;
receive, from a client device, a desired viewpoint from which to view the virtual object;
select one or more viewpoints from the plurality of viewpoints based on the desired viewpoint; and
send, to the client device, rendering data including the simplified geometric representation and an associated view-dependent texture that are associated with each of the selected one or more viewpoints, the rendering data being configured for rendering an image of the virtual object from the desired viewpoint.

11. The one or more computer-readable non-transitory storage media of claim 10, wherein selecting the one or more viewpoints from the plurality of viewpoints based on the desired viewpoint comprises:
prioritizing one or more of the plurality of viewpoints based on a relative location of the desired viewpoint with respect to the virtual object; and
selecting one or more of the plurality of viewpoints based on their prioritization.

12. The one or more computer-readable non-transitory storage media of claim 10, wherein, for each of the plurality of viewpoints, the simplified geometric representation is generated prior to receiving the desired viewpoint from the client device.

13. The one or more computer-readable non-transitory storage media of claim 10, wherein the software is further operable when executed to:
generate, for each of the selected one or more viewpoints, the view-dependent texture associated with the simplified geometric representation in response to selecting the one or more viewpoints from the plurality of viewpoints.

14. The one or more computer-readable non-transitory storage media of claim 13, wherein, for each of the selected one or more viewpoints, the view-dependent texture is generated from the selected viewpoint based on lighting conditions within a virtual environment.

15. The one or more computer-readable non-transitory storage media of claim 10, wherein the software is further operable when executed to:
generate a shadow texture of the virtual object based on lighting conditions within a virtual environment, and
wherein the rendering data further includes the shadow texture.

16. A system comprising: one or more processors; and one or more computer-readable non-transitory storage media in communication with the one or more processors, the one or more computer-readable non-transitory storage media comprising instructions that when executed by the one or more processors, cause the system to perform:
generate, for a virtual object defined by a geometric representation, a plurality of viewpoints surrounding the virtual object;
generate, for each of the plurality of viewpoints, a simplified geometric representation of the virtual object based on the viewpoint, wherein the simplified geometric representation has a lower resolution than the geometric representation of the virtual object;
receive, from a client device, a desired viewpoint from which to view the virtual object;
select one or more viewpoints from the plurality of viewpoints based on the desired viewpoint; and
send, to the client device, rendering data including the simplified geometric representation and an associated view-dependent texture that are associated with each of the selected one or more viewpoints, the rendering data being configured for rendering an image of the virtual object from the desired viewpoint.

17. The system of claim 16, wherein selecting the one or more viewpoints from the plurality of viewpoints based on the desired viewpoint comprises:
prioritizing one or more of the plurality of viewpoints based on a relative location of the desired viewpoint with respect to the virtual object; and
selecting one or more of the plurality of viewpoints based on their prioritization.

18. The system of claim 16, wherein, for each of the plurality of viewpoints, the simplified geometric representation is generated prior to receiving the desired viewpoint from the client device.

19. The system of claim 16, wherein the one or more computer-readable non-transitory storage media further comprise instructions that when executed by the one or more processors, cause the system to perform:
generate, for each of the selected one or more viewpoints, the view-dependent texture associated with the simplified geometric representation in response to selecting the one or more viewpoints from the plurality of viewpoints.

20. The system of claim 19, wherein, for each of the selected one or more viewpoints, the view-dependent texture is generated from the selected viewpoint based on lighting conditions within a virtual environment.
